(19) United States
(12) Patent Application Publication
(10) Pub. No.: US 2018/0193993 A1
(43) Pub. Date: Jul. 12, 2018

(54) Compact Impacting Apparatus

(71) Applicants: Christopher Pedicini, Franklin, TN (US); John Witzigreuter, Canton, GA (US)

(72) Inventors: Christopher Pedicini, Franklin, TN (US); John Witzigreuter, Canton, GA (US)

(73) Assignee: Tricord Solutions, Inc., Franklin, TN (US)

(21) Appl. No.: 15/614,340

(22) Filed: Jun. 5, 2017

Related U.S. Application Data
(60) Provisional application No. 62/498,796, filed on Jan. 9, 2017.

(51) Int. Cl. B25D 11/10; B25D 17/06

(52) U.S. Cl. CPC B25D 11/102; B25D 11/06; B25D 17/06

(57) ABSTRACT

A compact impacting apparatus includes a spring anvil assembly with a spring, an anvil, and a barrel cam. A cam follower engages the barrel cam to energize the spring anvil assembly. The spring anvil assembly is thereafter released to impact a striker, which striker delivers impact force to an impact target. The spring anvil assembly may be biased in a starting operational position by the weight of the apparatus or the impact target. The spring anvil assembly may be disposed against a rotating pusher plate while engaged by the cam follower. Force of impact may be adjusted by repositioning the pusher plate and or changing the compression of the spring of the spring anvil assembly. The cam follower provides for repeated impacts upon the impact target and the striker holds the impact target in place for effective impacting.

### CROSS-REFERENCE TO RELATED APPLICATIONS

The present disclosure is a non-provisional application of and claims priority under 35 U.S.C. § 119 on the pending U.S. Provisional Application Ser. No. 62/498,796, filed on Jan. 9, 2017, the disclosure of which is incorporated by reference.

### FIELD OF THE DISCLOSURE

The present disclosure relates to impacting apparatuses, and, more particularly, to such impacting apparatus for driving fence posts, breaking concrete, setting rivets, driving nails and otherwise performing multiple continuous impacts.

### BACKGROUND

Impacting apparatuses (also referred to herein as a “driver,” “gun” or “device”) known in the art often may be configured for an entirely portable operation. Contractors commonly use power-assisted devices for impacting a surface and/or driving an object into a substrate. These power-assisted apparatuses can be portable (i.e., not connected or tethered to an air compressor or wall outlet) or non-portable.

A common impacting apparatus uses a source of compressed air to actuate a guide assembly to push an object into a substrate. For applications in which portability is not required, this is a very functional system and allows rapid delivery of fasteners for quick assembly. A disadvantage is that it does however require that the user purchase an air compressor and associated air-lines in order to use this system. A further disadvantage is the inconvenience of the device being tethered (through an air hose) to an air compressor.

To solve this problem, several types of portable impacting devices operate off of fuel cells. Typically, these guns have a guide assembly in which a fuel is introduced along with oxygen from the air. The subsequent mixture is ignited with the resulting expansion of gases pushing the guide assembly and thus driving an object into a substrate. This design is complicated and expensive. Both electricity and fuel are required as the spark source derives its energy typically from batteries. The chambering of an explosive mixture of fuel, the use of consumable fuel cartridges, the loud report and the release of combustion products are all disadvantages of this solution.

A final commercially available solution is to use a flywheel mechanism and clutch the flywheel to an anvil that impacts a substrate. This tool is capable of impacting very quickly. The primary drawback to such a tool is the large weight and size as compared to pneumatic counterparts. Additionally, the drive mechanism is very complicated, which gives a high retail cost.

Clearly, and based on the above efforts, a need exists to provide portable solution for impacting that is unencumbered by fuel cells or air hoses. Additionally, the solution ought to provide a low reactionary feel, and be simple, cost effective and robust in operation.

The prior art teaches several additional ways of impacting. The first technique is based on a multiple impact design. In this design, a motor or other power source is connected to an impact anvil through either a lost motion coupling or other device. This allows the power source to make multiple impacts on an object to drive it into a substrate. However, such multiple impact designs are not very efficient because of the constant motion reversal and the limited operator production speed.

A second design includes the use of potential energy storage mechanisms (in the form of a mechanical spring). In these designs, the spring is cocked (or activated) through an electric motor. Once the spring is sufficiently compressed, the energy is released from the spring into a striker, thus impacting the striker and/or a substrate. Several drawbacks exist to this design. These include the need for a complex system of compressing and controlling the spring, and in order to store sufficient energy, the spring must be very heavy and bulky. Additionally, the spring suffers from fatigue, which gives the tool a very short life. Finally, metal springs must move a significant amount of mass in order to decompress, and the result is that these low-speed impacting devices result in a high reactionary force on the user.

To improve upon this design, an air spring has been used to replace the mechanical spring, i.e., compressing air within a guide assembly and then releasing the compressed air by use of a gear drive. One particularly troublesome issue with this design is the safety hazard in the event that the anvil jams on the downward stroke and the operator tries to clear the jam, he is subject to the full force of the anvil, since the anvil is predisposed to the down position in all of these types of devices. A further disadvantage to the air spring results from the need to have the ratcheting mechanism as part of the anvil drive. This mechanism adds weight and causes significant problems in controlling the drive action since the weight must be stopped at the end of the stroke. This added mass slows the drive stroke and increases the reactionary force on the operator. Additionally, because significant kinetic energy is contained within the air spring and piston assembly the unit suffers from poor efficiency. This design is further subject to a complicated drive system for coupling and uncoupling the air spring and ratchet from the drive train, which increases the production cost and reduces the system reliability.

A third means for impacting that is taught includes the use of flywheels as energy storage means. The flywheels are used to launch a hammering anvil that impacts a substrate. One major drawback to this design is the problem of coupling the flywheel to the driving anvil. This prior art teaches the use of a friction clutching mechanism that is both complicated, heavy and subject to wear. Further limiting this approach is the difficulty in controlling the energy, the mechanism requires enough energy to impact effectively, but retains significant energy in the flywheel after the drive is complete. This further increases the design complexity and size of such prior art devices.

All of the currently available devices suffer from one or more the following disadvantages:
Complex, expensive and unreliable designs. Fuel powered mechanisms such as Paslode™ achieve portability but require consumable fuels and are expensive. Rotating flywheel designs such as Dewalt™ have complicated coupling or clutching mechanisms based on frictional means. This adds to their expense.
Poor ergonomics. The fuel powered mechanisms have loud combustion reports and combustion fumes. The multiple impact devices are fatiguing and are noisy.
Non-portability. Traditional impacting devices are tethered to a fixed compressor and thus must maintain a separate supply line.
High reaction force and short life. Mechanical spring driven mechanisms have high tool reaction forces because of their long drive times. Additionally, the springs are not rated for these types of duty cycles leading to premature failure.
Safety issues. The prior art “air spring” and heavy spring driven designs suffer from safety issues for impacting since the predisposition of the anvil is towards the substrate. During jam clearing, this can cause the anvil to strike the operator's hand.
The return mechanisms in most of these devices involve taking some of the drive energy. Either there is a bungee or spring return of the driving anvil assembly or there is a vacuum or air pressure spring formed during the movement of the anvil. All of these mechanisms take energy away from the drive stroke and decrease efficiency.

In light of these various disadvantages, there exists the need for a fastener driving apparatus that overcomes these various disadvantages of the prior art, while still retaining the benefits of the prior art.

### SUMMARY OF THE DISCLOSURE

In accordance with the present disclosure, an impacting apparatus is described which derives its power from an electrical source, preferably rechargeable batteries, and uses a motor to actuate a spring anvil assembly. The spring anvil assembly can include either a mechanical spring coupled to a pushing element (hereinafter referred to as a piston) or a gas spring that is coupled to a piston. In an embodiment where the spring is a mechanical spring, the spring may be comprised of titanium, carbon fiber, an elastomer or steel, for example. After a sufficient movement of a piston in the spring anvil assembly, the piston commences movement and accelerates the spring anvil assembly (which assembly includes an anvil and a spring coupled to a piston, for example.) The contact of the spring piston with a pusher plate (which pusher plate is secured to the tool frame) causes the spring anvil assembly to move, and in an embodiment, the movement is toward and into contact with a striker, substrate or object to be driven into a substrate such that the anvil impacts the striker or substrate or drives the object into the substrate. A post, fastener or other driven object can position the spring anvil assembly and/or striker for the commencement of another operating cycle.

The impacting/driving cycle of the apparatus disclosed herein may start with an electrical signal, after which a circuit connects a motor to the electrical power source. The motor is coupled to the spring anvil assembly through an interrupted drive mechanism, cam, or any other drive mechanism capable of providing for continuous impacting/driving. In an operational cycle of the drive mechanism, the mechanism alternatively (1) actuates the piston of the spring anvil assembly and (2) ceases actuation of the piston to allow pressure or other force(s) to act on the spring piston. For example, during a portion of its cycle, an interrupted drive mechanism may move the piston to increase potential energy stored within the spring assembly. In the next step of the cycle, the mechanism ceases acting on the spring anvil assembly to allow the accumulated potential energy within the spring assembly to act on and actuate the piston. The piston thereupon moves and causes the spring anvil assembly to move and impact a substrate or striker or drive an object, for example. A spring or other return mechanism is operatively coupled to the spring anvil assembly to return the spring anvil assembly to an initial position after the anvil has impacted the striker or substrate or driven an object. In an embodiment, at least one bumper is disposed within or outside of the spring anvil assembly to reduce wear and tear on the spring anvil assembly that may otherwise occur in operation of the apparatus.

In an embodiment, the stroke or movement of the piston of the spring anvil assembly is less than one half the total movement of the spring anvil assembly. Further preferred is that the movement of the spring piston results in a volume decrease within the gas spring of less than 20% of the initial volume, thus reducing losses from heat of compression.

In an embodiment, a sensor and a control circuit are provided for determining at least one position of the spring and/or anvil to enable the proper timing for stopping the cycle of the apparatus and/or to detect a jam condition of the apparatus.

Accordingly, and in addition to the objects and advantages of the portable impacting apparatus as described above, several objects and advantages of the present disclosure are:
To provide a simple design for impacting apparatuses that has a significantly lower production cost than currently available devices and that is portable and does not require an air compressor.
To provide an impacting apparatus that mimics the pneumatic fastener performance without a tethered air compressor.
To provide an electrical driven high power impacting apparatus that has very little wear.
To provide an electric motor driven impacting apparatus in which energy is not stored behind the driving anvil, thus greatly enhancing tool safety.
To provide a more energy efficient mechanism for driving objects and impacting substrates than is presently achievable with a compressed air design.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 shows a view of an impacting apparatus, in accordance with an exemplary embodiment of the present disclosure;

FIG. 2 shows another view of an impacting apparatus in accordance with an exemplary embodiment of the present disclosure;

FIG. 3 shows a cutaway view of an operational phase of an impacting apparatus, prior to the anvil thereof contacting the striker thereof, in accordance with an exemplary embodiment of the present disclosure;

FIG. 4 shows another cutaway view of an operational phase of an impacting apparatus, after the anvil thereof has contacted the striker thereof, in accordance with an exemplary embodiment of the present disclosure;

FIG. 5 shows a spring anvil assembly of an impacting apparatus, in accordance with an exemplary embodiment of the present disclosure;

FIG. 6 shows a drive mechanism of an impacting apparatus, in accordance with an exemplary embodiment of the present disclosure, and

FIG. 7 shows a cam of an impacting apparatus, in accordance with an exemplary embodiment of the resent disclosure.

Like reference numerals refer to like parts throughout the description of several views of the drawings.

### DETAILED DESCRIPTION OF THE DISCLOSURE

The best mode for carrying out the present disclosure is presented in terms of its preferred embodiment, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure. Furthermore, although the following relates substantially to one embodiment of the design, it will be understood by those familiar with the art that changes to materials, part descriptions and geometries can be made without departing from the spirit of the disclosure. It is further understood that references such as front, back or top dead center, bottom dead center do not refer to exact positions but approximate positions as understood in the context of the geometry in the attached figures.

The terms “a” and “an” herein do not denote a limitation of quantity, but rather denote the presence of at least one of the referenced items.

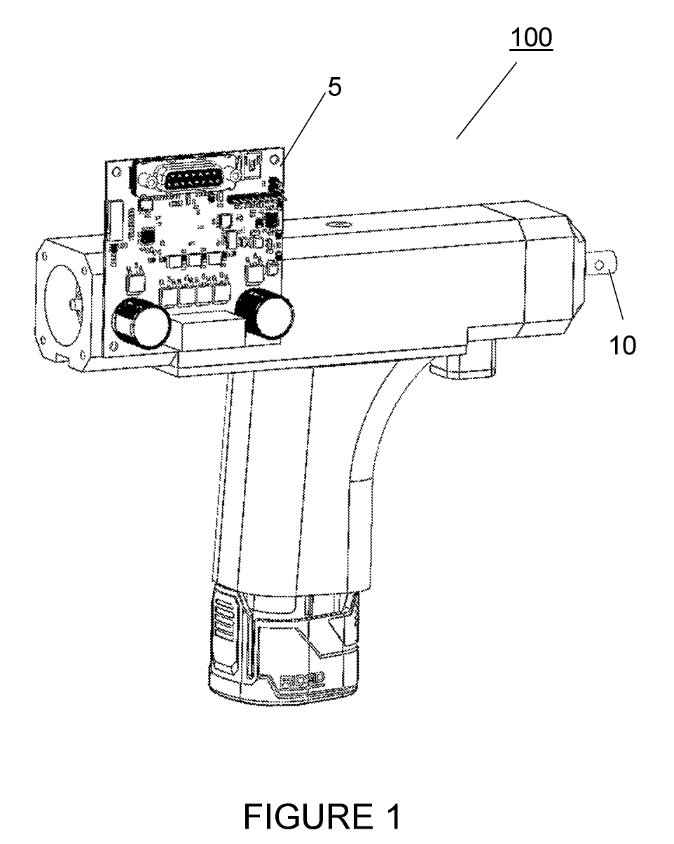

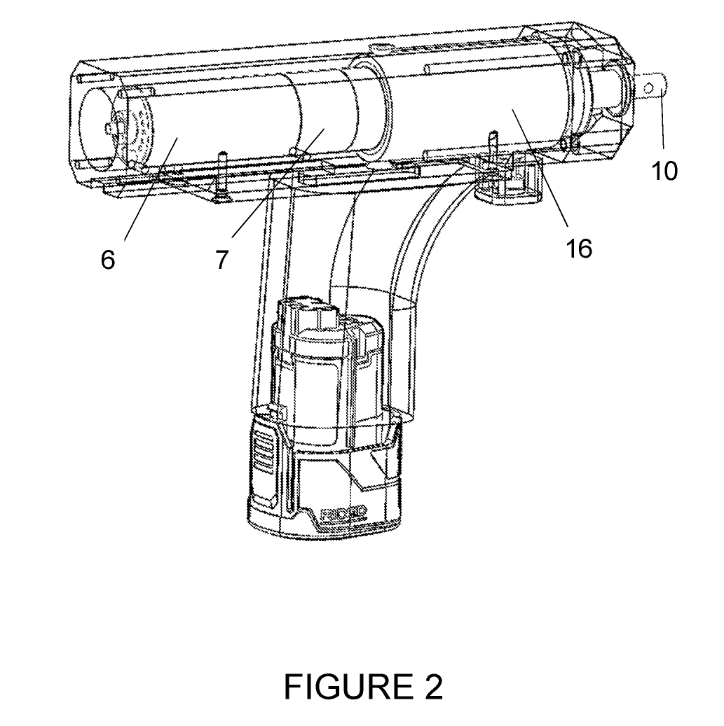

Referring to FIGS. 1 and 2, the present disclosure provides for a compact impacting apparatus 100. In an embodiment, the apparatus 100 comprises a power source 2, a control circuit 5, a motor 6, spring anvil assembly 17 (including a spring 14 and anvil 8, and, in an embodiment, a cam such as a barrel cam 20), a striker 10, a cam follower 12, and at least one bumper 11. A spring 14 is at least partially disposed within the spring anvil assembly 17. The at least one bumper 11 is preferably disposed within the apparatus 100 or (in proximity to a position where the striker 10 impacts a target object) to absorb a portion of the force of impact of the striker 10.

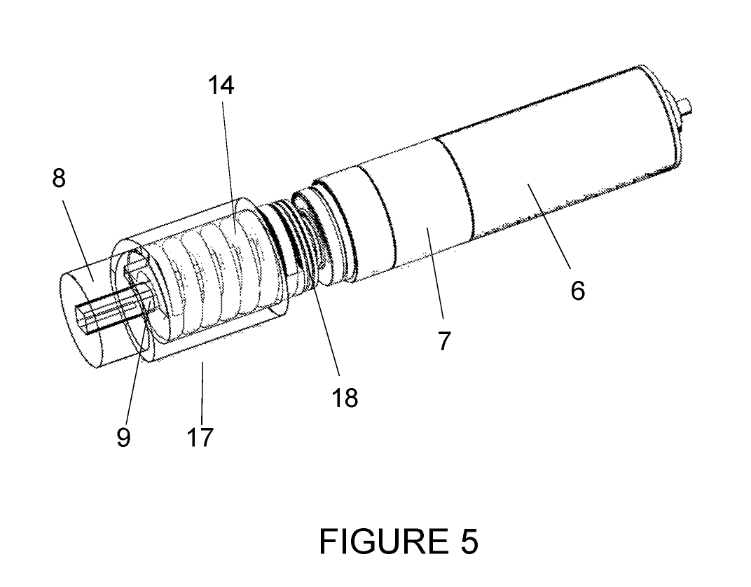

Referring to FIG. 5, the spring anvil assembly 17 may comprise, in an embodiment, a cam or a barrel cam 20 that engages with a cam follower 12 to energize the spring 10 of the spring anvil assembly 17. In such a cam or barrel cam embodiment, it will be apparent that the spring anvil assembly 17 is configured to permit effectively instantaneous transition from when the cam follower 12 is actuating the barrel cam 20 to compress the spring to when there is no engagement between the follower 12 and the cam or barrel cam 20. In an embodiment, anvil 8 may comprise cam or barrel cam 20.

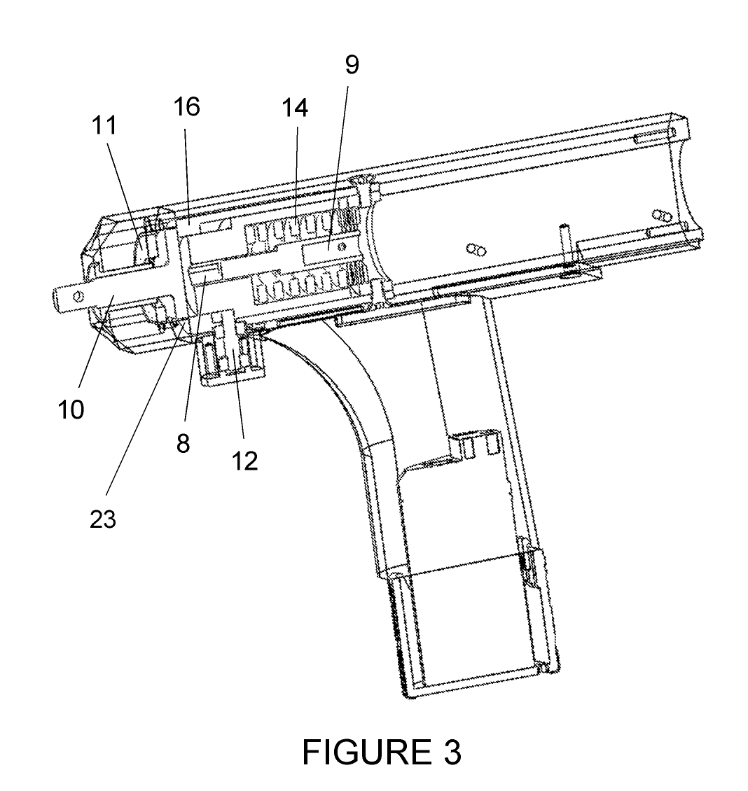

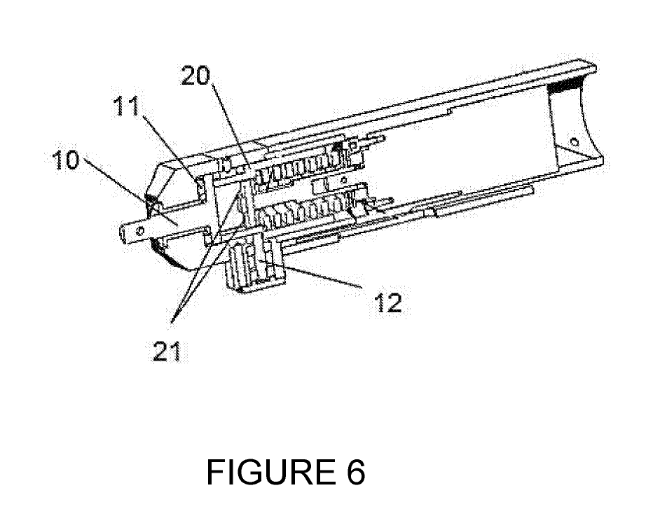

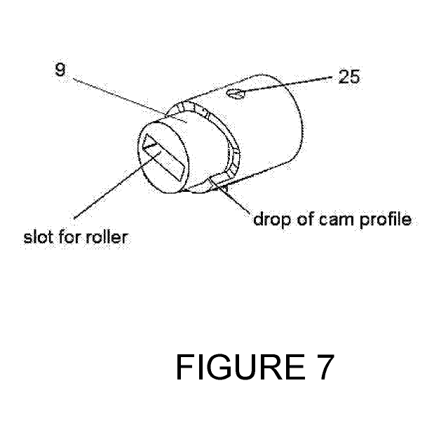

In an embodiment, the spring anvil assembly 17 incorporating the cam or barrel cam 20 engages the spring 10 to store potential energy within the spring 10, and as shown in FIG. 3. This is accomplished by rotating the spring anvil assembly 17 with the motor 6, via the output of a gear reducer 7 which is attached to a drive shaft 9 of the motor. In an embodiment, the drive shaft 9 has a square drive allowing the spring anvil assembly 17 to rotate but also allowing it to slide on the drive shaft 9 to impact the striker 10. In another embodiment and as shown in FIGS. 6 and 7, the spring anvil assembly 17 may be rotated by rollers 21, the rotation by the rollers 21 of the spring anvil assembly 17 causes the cam follower 12 to engage the cam or barrel cam 20 for a time to generate energy in the spring 10 of the spring anvil assembly 17, i.e., by compressing the spring. The profile of the cam or barrel cam 20 is configured such that after a certain amount of compression and as shown in FIG. 7, a drop both allows the spring anvil assembly 17 to move linearly to impact a striker 10 and ensures that the cam follower 12 does not hit or otherwise impede the barrel cam 20 until after the spring anvil assembly 17 impacts the striker 10. Rollers 21 do not inhibit the spring anvil assembly 17 from moving linearly to impact a striker 10.

A pusher plate is used to support one end of the spring in the spring anvil assembly. In an embodiment, and as shown in FIG. 5, a rotating pusher plate 18 is used to support one end of the spring 14 in the spring anvil assembly 27. As the spring 14 compresses the force on the pusher plate 18 increases. The rotating side of the pusher plate allows the spring 14 and the anvil 8 (of the spring anvil assembly 17) to rotate together. In another embodiment, the pusher plate does not rotate, and the spring anvil assembly further comprises a rotating member to allow the spring to remain stationary with respect to the anvil.

In an embodiment, the initial force of the spring 14 (i.e., prior to loading or storage of energy in the spring) is at least 20 pounds and more preferably 50 pounds. The spring anvil assembly 17 incorporating the barrel cam 20 thereafter disengages from the cam follower 12, allowing pressure or other forces to act on the spring anvil assembly 17 and cause the spring anvil assembly 17 (and in a preferred embodiment, the anvil 8 of the spring anvil assembly 17) to impact the striker 10 and deliver its energy. The control circuit 5 is tuned to prevent further engagement until after the striker 10 has returned to an approximate starting position. A sensor 25 may be provided and may communicate with the control circuit 5 for determining at least one position of the spring 14 and/or anvil 8 to enable the proper timing for stopping the cycle of the apparatus 100 and/or to detect a jam condition of the apparatus 100. The barrel cam 20 may thereafter again act on the cam follower 12 to again store potential energy within the spring anvil assembly. The apparatus 100 is preferably configured to allow for continuous impacting, by way of the rotating cam 20, for example (as shown in the figures), to provide for such continuous impacting.

In an embodiment, the profile of the cam 20 is such that that during the portion of the operational cycle in which the spring is being compressed, the torque required to operate the cam varies no more than 50% for at least 70% of the cam rotation in which the gas spring is being energized.

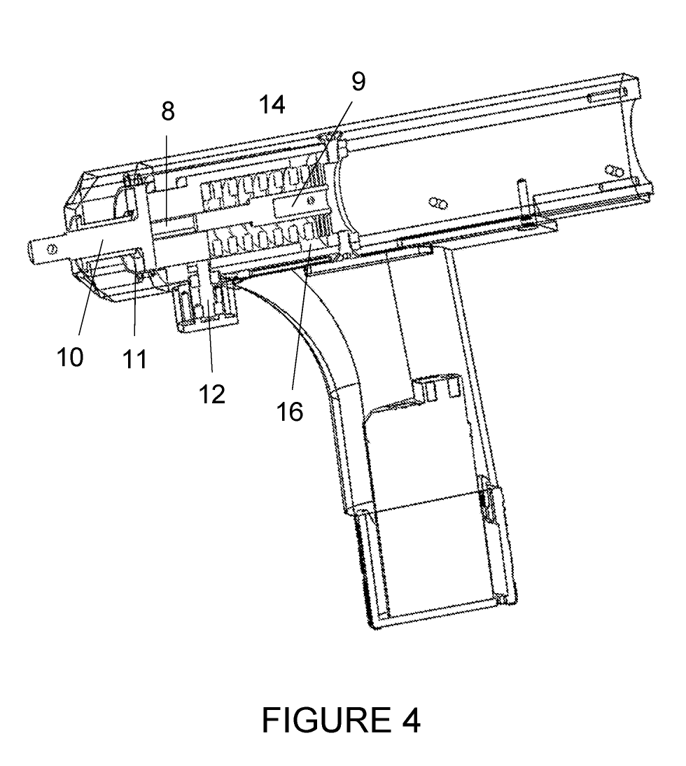

In an embodiment, the spring anvil assembly 17 is operatively coupled to the spring 14, such that when the spring anvil assembly 17 is released under pressure the force from the spring 14 is imparted into the spring anvil assembly 17, causing the spring anvil assembly 17 to move in a direction towards and eventually contact and impact the striker 10 (as shown in FIG. 4), which striker 10 moves to transmit the force of the impact to an impact target, such as a nail, rivet, or concrete for example. The striker 10 facilitates positioning of the impact target so that the impact target can receive the force of the striker 10 and so that the impact target can remain in a position to receive such force when the apparatus 100 is providing multiple or continuous impacts. It was discovered during the course of development that the ratio of the mass of the spring anvil assembly 17 to the total apparatus mass was important to the efficiency of the apparatus 100. It is preferred to have the moving mass (which in this case is the spring anvil assembly 17) be less than 20% of the total mass (which includes all components of the apparatus). This allows the present disclosure to have increased efficiency in transferring the potential energy into driving energy on the object or substrate. In an embodiment, the spring anvil assembly 17 has a mass of 150 grams and the tool has a mass of 1500 grams. The spring anvil assembly 17 may be operatively coupled to a guide, shaft, or other structure that limits its range of motion. In the preferred embodiment, apparatus 100 comprises a cylinder in which the spring anvil assembly 17 is at least partially disposed, and in such an embodiment, a cylinder bearing 16 serves to limit the range of motion of the spring anvil assembly 17.

The at least one bumper 11 may be of an elastic material, and may be disposed on the apparatus 100 at any position where it is capable of absorbing a portion of the force of impact by the spring anvil assembly 17 or the striker 10.

The striker 10 may further comprise a return mechanism to enable the striker 10 to return to its initial position (after it has been acted on and moved by the spring anvil assembly to impact a target). In an embodiment, the return mechanism is a return spring that is disposed on or in a guide or shaft that constrains the striker 10, which return spring would be disposed nearer the end or portion of striker 10 that is distal to the spring 14. After the spring anvil assembly 17 has contacted and moved the striker to impact a surface and/or drive an object, the return mechanism imparts a force on the striker 10 to cause the striker to return to a position where it may again be operatively acted upon by the spring anvil assembly 17. In the embodiment where the return mechanism is a spring, the spring may be disposed with respect to the striker 10 such that motion of the striker 10 toward an impact target also causes the spring to compress, and after the striker 10 has reached the end of its driven stroke, the compressed spring decompresses to actuate the striker 10 to its earlier or original position.

An alternate embodiment for returning the striker 10 to its cycle start position is to use the force of the impact target (such as a post, spike, nail or rivet) to bring the striker 10 into its starting position. In such an embodiment, the return mechanism described above is omitted, and the striker 10 is disposed in the down or out position (i.e., distal to the spring 14) and rests atop the striker target, before the operational cycle commences. When the striker 10 is in such a down position, the operational cycle is unable to commence, which improves the safety profile of the apparatus 100. To allow the apparatus 100 to operate, the striker 10 is placed into contact with the impact target, and the weight of the apparatus 100 or force applied to the tool by the user, causes the striker to be moved and disposed proximate to the spring 11 (i.e., the starting position of operational cycle, where the spring 10 may be acted upon by the barrel cam 20.) The striker 10 can also be spring loaded or otherwise biased away from the spring anvil assembly 17, further adding to the safety of the tool.

This embodiment has several advantages. The first is that it would make it less likely to dry fire the apparatus 100 as the apparatus 100 must be in contact with the impact target to be able to operate. The second advantage is that no return mechanism would be required to reset the mechanism, thus eliminating an item that may otherwise wear during use of the apparatus 100.

In an exemplary embodiment, the impact target is utilized to move (push) the striker 10 into position against the cylinder bearing 16. A stop 23 within the apparatus 100 (disposed on or in the cylinder for example) may also be provided for preventing the striker 10 from moving with the spring anvil assembly 17 as the spring anvil assembly 17 is energized. In this position the impact target would rest against the striker 10 and the striker 10 would rest against a stop 23, preventing the impact target from moving up with the spring anvil assembly 17 when the spring 14 is being actuated to store potential energy.

In another embodiment, the apparatus 100 further comprises a power adjustment mechanism for adjusting the force of impact by the apparatus 100. In an embodiment, the power adjustment mechanism comprises adjustable positioning for compression of the spring 14. By adjusting positioning of the rotating pusher plate 18, for example, the amount of compression of the spring 14 can be adjusted, and force of impact is consequently adjusted by the change to the amount of compression of the spring 14. The position of the rotating pusher plate 18 may be adjusted by way of a screw that may be actuated to reposition the rotating pusher plate 18 or by disposing the rotating pusher plate 18 on a slider, which slider may allow the rotating pusher plate 18 to be repositioned.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

Components

| | |
|---|---|
| 100 | Impactor |
| 1 | Handle |
| 2 | Power Source |
| 5 | Control Circuit |
| 6 | Motor |
| 7 | Gear Reducer |
| 8 | Anvil |
| 9 | Drive Shaft |
| 10 | Striker |
| 11 | Bumper |
| 12 | Cam Follower |
| 14 | Spring |
| 16 | Cylinder Bearing |
| 17 | Spring Anvil Assembly |
| 18 | Rotating Pusher Plate |
| 20 | Barrel Cam |
| 21 | Roller |
| 22 | Return Mechanism |
| 23 | Stop |

What is claimed is:

1. An impacting apparatus, the apparatus comprising
a power source,
a control circuit,
a motor,
a striker,
a spring anvil assembly, said spring anvil assembly comprising a spring, an anvil and a barrel cam,
and a cam follower, said cam follower capable of engaging said spring anvil assembly to energize said spring anvil assembly and thereafter allowing said energized spring anvil assembly to accelerate toward said striker,
wherein after potential energy is increased in said spring anvil assembly by engagement of said cam follower with said barrel cam, potential energy from said spring anvil assembly thereafter decreases while accelerating the spring anvil assembly to impact said striker.

2. The impacting apparatus of claim 1, wherein said spring comprises one of a mechanical spring, a titanium spring, a carbon fiber spring, a steel spring, an elastomer and a gas spring.

3. The apparatus of claim 1, said apparatus further comprising a pusher plate against which said spring anvil assembly is disposed for at least a portion of the operating cycle when said cam follower engages said barrel cam.

4. The impacting apparatus of claim 1, wherein said control circuit further comprises at least one sensor, wherein said at least one sensor may determine at least one of the position of said anvil and the position of said striker.

5. The impacting apparatus of claim 1, said apparatus comprising a bumper for absorbing the impact of one of said spring anvil assembly and said striker during an operational cycle of the apparatus.

6. The impacting apparatus of claim 1, said apparatus further comprising a return mechanism for returning the striker to an initial position after impacting an object.

7. The impacting apparatus of claim 1, said apparatus further comprising a return mechanism for biasing said spring anvil assembly to a position where said spring anvil assembly is in a position to be energized.

8. The impacting apparatus of claim 1, wherein said spring has a force of at least 30 pounds for one portion of the operational cycle.

9. The impacting apparatus of claim 3, said apparatus further comprising a power adjustment mechanism that adjusts the force of impact of the spring anvil assembly, said power adjustment mechanism comprising one of an adjustment to the position of the pusher plate and an adjustment to the amount of compression of the spring.

10. The impacting mechanism of claim 2, wherein said barrel cam comprises a cam profile, and wherein said cam profile is configured such that during the portion of the operational cycle in which the spring is being compressed, the torque required to operate the cam varies no more than 50% for at least 70% of the cam rotation in which the gas spring is being energized.

11. The impacting apparatus of claim 1, wherein the mass of said spring anvil assembly is less than 15% of the mass of the apparatus.

12. A impacting apparatus, the apparatus comprising
a power source,
a control circuit,
a motor,
a spring anvil assembly, said spring anvil assembly comprising a spring and an anvil, and a barrel cam, (I just want to make sure that it is understood that the barrel cam and the anvil could be the same part or separate parts.)
a striker,
an impact target, and
a cam follower capable of engaging said spring anvil assembly to energize said spring anvil assembly and thereafter cease applying such a force on said spring anvil assembly,
wherein when said cam follower engages said spring anvil assembly, potential energy is stored in said spring, and when said cam follower thereafter ceases applying a force on said spring anvil assembly said spring releases its potential energy and accelerates said spring anvil assembly to impact the striker, and
wherein said striker contacts said impact target to deliver the impact energy from said spring anvil assembly to said impact target.

13. The impacting apparatus of claim 12, wherein the striker is biased away from the spring anvil assembly by an elastic element.

14. The impacting apparatus of claim 12, wherein said spring comprises one of a steel, titanium, elastomer, gas spring or carbon fiber spring.

15. The impacting apparatus of claim 12, wherein said spring anvil assembly is biased back to a position at which it may be energized by said cam follower by force from one of the impact target and the weight of the apparatus.

16. The impacting apparatus of claim 12, said apparatus further comprising a pusher plate, wherein said spring anvil assembly acts on the pusher plate during a portion of the operational cycle of the apparatus to compress the spring of the spring anvil assembly.

17. The impacting apparatus of claim 16, said impacting apparatus further comprising a power adjustment mechanism for adjusting the force of impact by the apparatus, said power adjustment mechanism comprising one of an adjustment to the position of the pusher plate and adjustment to the amount of compression of the spring of the spring anvil assembly.

18. A impacting apparatus, the apparatus comprising
a power source,
a control circuit,
a motor,
a spring anvil assembly, said spring anvil assembly comprising a spring, an anvil, and a cam,
a striker,
an impact target, and
a cam follower capable of engaging said spring anvil assembly via the cam to energize said spring anvil assembly and thereafter to cease applying a force on said spring anvil assembly,
wherein when said cam follower engages said spring anvil assembly, potential energy is stored in said spring, and when said cam follower thereafter ceases applying a force on said spring anvil assembly, said spring releases its potential energy and accelerates said spring anvil assembly to impact said striker,
wherein said striker contacts said impact target to deliver the impact energy from said spring anvil assembly to said impact target, and
wherein said spring anvil assembly is biased to a position where it can be so engaged by said cam follower by one of the impact target and the weight of the apparatus.

19. The apparatus of claim 18, said apparatus further comprising a pusher plate against which said spring anvil assembly is disposed for at least a portion of the operating cycle when said cam follower engages said cam.

20. The apparatus of claim 18, wherein said cam comprises a barrel cam.
